(19) United States
(12) Patent Application Publication
(10) Pub. No.: US 2012/0227629 A1
(43) Pub. Date: Sep. 13, 2012

(54) Beneficial Thermo-Chemical Treatment of Kaolin with Ammonium Polyphosphate

(75) Inventors: Kenneth Folmar, Macon, GA (US); Mitchell Willis, Bainbridge, GA (US)

(73) Assignee: BASF Corporation, Florham Park, NJ (US)

(21) Appl. No.: 13/042,790

(22) Filed: Mar. 8, 2011

(51) Int. Cl. C04B 14/10; C08K 3/34; D21H 17/68

(52) U.S. Cl. 106/486; 162/181.8; 524/447

(57) ABSTRACT

Minerals which can be anionically dispersed in water such as kaolin are provided with unique structure by adding small amounts of a polyphosphate structuring agent and heating the mixture to allow reaction of the structuring agent with the mineral.

### FIELD OF THE INVENTION

Unique properties can be engineered into minerals such as kaolin by the addition of graduated amounts of ammonium polyphosphate followed by heat treatment.

### BACKGROUND OF THE INVENTION

In the manufacture of paper and paper board, it is well-known to incorporate quantities of inorganic fillers into the fibrous web in order to improve product quality. Titanium dioxide is widely used to improve brightness and opacity, but it is an expensive pigment. In recent years, considerable efforts have been made to develop satisfactory replacements for titanium dioxide. Substantially anhydrous kaolin clays prepared by partially or fully calcining a fine particle size fraction of crude kaolin clay is now a replacement pigment of choice. Calcined kaolin clay opacifying pigments, such as the products supplied under the registered trademarks ANSILEX and ANSILEX 93 by Engelhard Corporation are exemplary. These products are substantially anhydrous white pigments and are widely used as fillers in paper sheets and paper board, as a coating pigment for paper, and as a pigment in paints and other filled systems. They consist of aggregates of clay particles, and exhibit exceptionally high light-scattering and opacifying characteristics when incorporated as a filler into paper. The particle size of these pigments is typically at least 65 percent by weight finer than 2 micrometers equivalent spherical diameter (ESD), and at least 50 percent by weight finer than 1 micrometer. The pigments exhibit low Valley abrasion values, generally less than 50 mg., and usually below 30 mg. In paint applications, the principal demand is for calcined clay pigments having a brightness (as measured by the well-known TAPPI method) of at least 88 percent, preferably above. The pigment is to have low surface area and a particle size distribution structure to control the sheen of the paint film at low levels.

On a commercial scale, kaolin calcination may be carried out in a rotary calciner with countercurrent flow of hot air or in a Nichols Herreshoff vertical furnace. In the laboratory, a muffle furnace is usually applied. Kaolin to be calcined is typically a finely dispersed powder with a Hegman grind of 4.5 or higher. This degree of dispersion is generally achieved by passing the dry kaolin powder through an appropriately designed pulverization process.

To one skilled in the art of kaolin calcination, kaolin, when heated, will undergo a series of crystalline form changes that offer significantly different physical and chemical property attributes. The first of these occurs in the 840° to 1200° F. (450°-650° C.) range. Here hydrous kaolin dehydroxylates with the formation of an amorphous essentially anhydrous material usually referred to as “metakaolin.” The metakaolin state is conveniently ascertained by acid solubility testing because the alumina in the clay is virtually completely soluble in strong mineral acid. Typically, about 45% by weight of metakaolin is soluble in hydrochloric acid of 18% strength. In contrast, solubility in hydrochloric acid of the alumina component in hydrated kaolin is very limited

As incremental heat is applied to metakaolin, its lattice will reconfigure to a gamma-alumina (spinel) phase. This typically occurs as the feed material reaches a temperature range of 1650° to 1750° F. Above this temperature, the gamma alumina incrementally converts to mullite. At 2300° F., the conversion to mullite is essentially complete. At higher temperature, the synthetic mineral matrix will again reconfigure into cristobalite. Once out of the metakaolin form, the alumina component of the matrix is minimally soluble in strong mineral acid. X-ray diffractometry (XRD) is a convenient way to assess the level of mullite present in the spinel lattice.

Calcined kaolin pigments have been used for several decades in a number of industrial applications such as paper coating, paper filling, paints, plastics, etc. In these applications the kaolin pigments impart to the finished products a number of desirable properties: TiO₂ extension/opacity, sheen control/gloss, voltage resistivity, strength (in plastics), friction (in paper). Paper coating and filling applications almost exclusively require fine fully calcined kaolin pigments such as the 93% brightness ANSILEX-93® pigment manufactured by Engelhard Corporation. See, for example, U.S. Pat. No. 3,586,523, Fanselow et al, which describes the production of such pigments from ultrafine Tertiary “hard” ultrafine kaolins. The term “fully calcined” is of interest because it defines a rather narrow range of calcined kaolin matrix structures. Calcination has been pushed into the spinel phase and arrested when only small degree of mullite has been incorporated into the spinel lattice. Control of this “degree of calcination” is critical in developing the combination of physical properties that define a calcined kaolin pigment. Key physical property attributes include particle size distribution, brightness, abrasion and control of residue i.e. e. aggregates larger than 44 microns (325 mesh) in size. The result is a high brightness pigment with excellent light scattering properties. In paper applications, it can efficiently extend the functionality of much costlier titanium dioxide pigments as well as modify the porosity of a paper coating.

It is well known in the industry that the brightness of uncalcined and calcined kaolin pigments is adversely affected by the presence of colored impurities, notably titaniferous and ferruginous impurities. These interfere with brightness development during calcination. Typically, fully calcined kaolin pigments are produced from fine hard middle Georgia Tertiary kaolin crudes, such as those mentioned in U.S. Pat. No. 3,586,523, which carry iron and titanium contamination of about 0.90-1.1% Fe₂O₃ and 1.0-1.8% TiO₂, respectively. It has long been the practice to remove these impurities to various extents by physical or physical-chemical means, such as froth flotation, selective flocculation, magnetic purification, bleaching and combinations thereof. It is also known that calcination generally increases brightness over that seen in hydrous kaolin used as feed, i.e. when the clay is “fully” calcined past the gamma alumina or spinel phase. A decrease in brightness can be seen until it is fired more intensively to include more mullite in the spinel lattice. As spinel converts to mullite, amorphous silica is expelled from the lattice. This enhances particle agglomeration for efficient light scattering but will suppress particle size distribution and increase product abrasion and residue content as well, all deleterious to paper pigment performance.

The use of calcined kaolin as a filler in commercial paint applications is limited due to deficiencies in product hardness for scrub and burnish resistance and higher than desired surface area that limits the coating's resistance to stain. One skilled in the art of kaolin calcination can increase the hardness of the mineral product by intensive firing to convert the product from typically 90% gamma aluminum (spinel)/10% mullite to matrix that can be 80% mullite or more. The Mohs hardness of spinel is in the 4.5 range. Converting 80% of the spinel to mullite will raise the product Mohs hardness into the 6.0 to 6.5 range which is in line with natural minerals like nepheline syenite and synthetic ceramic microspheres which have broader use in both interior and exterior paint applications. As the spinel lattice converts to mullite and the mineral matrix consolidates, control of particle size distribution control and surface area is problematic due to the accompanied generation of excessive +325 mesh (44 micron) aggregates. Product brightness will also be suppressed. The use of fluxes (sodium borate, sodium silicate, etc.) cannot reduce the calcining temperature sufficiently to offset these effects.

Besides kaolin, other filler materials transition to different crystalline phases during heating. Aluminas, such as boehmite, are frequently used for their functional value in plastics and other applications. An important parameter is the particle size and corresponding surface area relationship of alumina and which relationship provides improved functional and strengths to the polymers and other systems in which alumina is employed. During heat treatment, or calcination, boehmite converts to a gamma phase then a delta phase alumina. As the phases change, there is a change in the relationship of pore volume distribution, or internal structure, to surface area. The optimal relationship between these properties varies for different types of plastics, adsorbents, and end uses of such materials. Certain boehmite alumna's have high surface that is not desirable for many applications. Commercial boehmite may vary in surface area from approximately 70 to >200 m²/g. Structuring to enhance the pore volume of alumina, or mixtures with other materials, to form cohesive structures that enhance diffusion, and other key physical properties, offers significant potential commercial value.

High solids mineral slurries, which are dispersed anionically, require structuring agents that have similar pH or characteristics to avoid flocculation. Thus, materials typically used to form structures, are limited. Those skilled in the art have used polyphosphoric acid (PPA) in mineral mixtures to impart functional enhancement to performance in cationic systems. Mixtures containing alumina gels and other hydrogels that generate performance synergy are well documented. Unfortunately, this practice in high solids anionic dispersed slurries is not practical due to the change in the zeta potential, which when mixing with PPA, results in flocculation.

### SUMMARY OF THE INVENTION

It has now been found that minerals, which can be anionically dispersed, when treated with small amounts of polyphosphate and then heated, are unexpectedly provided with internal structuring so as to increase the internal porosity of the mineral. Minerals so treated, can maintain internal pore volume, even as the hardness of the mineral increases during intensive heat treatment.

### BRIEF DESCRIPTION OF THE DRAWINGS

FIG. 1 is a graph illustrating the distribution of pore volume of a boehmite control versus a structured boehmite in accordance with the present invention.

FIG. 2 is a graph illustrating the distribution of pore volume of boehmite versus kaolin.

FIG. 3 is a graph illustrating the pore volume distribution of a mixture of structured boehmite and kaolin versus a kaolin control and a boehmite control.

FIG. 4 is a graph illustrating the pore volume distribution of a mixture of structured boehmite and kaolin versus structured boehmite.

FIG. 5 is a graph of the pore volume distribution of a mixture of structured boehmite and kaolin versus a mixture of boehmite control and kaolin.

### DETAILED DESCRIPTION OF THE INVENTION

The materials that can be treated in accordance with this invention are minerals which can normally be dispersed in water with an anionic dispersing agent. Non-limiting examples include metal oxide pigments such as titanium dioxide, alkaline earth metal carbonates such as calcium carbonate, aluminas, silicas, and alumina/silica minerals, in particular, clays. The invention is particularly useful for treating and providing internal structuring to calcined kaolin and aluminas that are transformed to transitional crystalline phases by heating.

The structuring agent which is used in the invention is a polyphosphate, whether as a solid polyphosphate salt or liquid polyphosphate such as ammonium polyphosphate. There does not appear to be any criticality in the length of the polyphosphate chain and, accordingly, di-polyphosphates, tri-polyphosphates, and higher polyphosphate chains to a thousand or more are useful in this invention. Mixtures of polyphosphate and orthophosphates such as phosphoric acid are possible, as long as the amount of the orthophosphoric acid component is not excessive. Preferably, the orthophosphoric acid content should not be greater than 50 wt. % of any structuring mixture with one or more polyphosphates. The amount of orthophosphate or orthophosphoric acid is to be minimized inasmuch as many, if not all, of the anionically dispersed minerals will flocculate in the presence of phosphoric acid, and not provide the structuring effect found. Flocculation also greatly hinders the processing of these materials. A particularly preferred class of structuring agents is the ammonium polyphosphates which are often soluble in water and are liquid which can be easily processed with aqueous slurries of the minerals to be treated. Of particular usefulness is a liquid ammonium phosphate 11-37-0 fertilizer, which has a polyphosphate content of 37% and an orthophosphate content of 27%. This material is 100% water soluble.

The amount of polyphosphate structuring agent added to the mineral to be treated to provide internal structuring, is minimal. Thus, amounts of polyphosphate as P₂O₅ added relative to mineral solids can range from as little as 0.01 to 5 wt. %. More specifically, amounts of polyphosphate as P₂O₅ will range from about 0.01 to 2 wt. % and, more particular still, from about 0.01 to 0.5 wt. %. It has been found that even these small amounts can yield significant changes in surface area and internal pore volume to the mineral treated relative to untreated minerals.

In general, the process of treating the mineral component to add internal structuring thereto includes slurrying the mineral in water and mixing the polyphosphate structuring agent in liquid form with the aqueous mineral slurry. A slurry dispersant can be included such as sodium hydroxide, sodium carbonate, sodium polyacrylate, sodium silicate, tetra-sodium pyrophosphate, sodium metasilicate, sodium hexametaphosphate, and/or sodium tri-polyphosphate. As above noted certain polyphosphates such as ammonium polyphosphate are in liquid form and can be simply added to the slurry. Other polyphosphate salts may need to be dissolved in a solvent. Inasmuch as the mixture is spray dried under vacuum or heating and a further heating step is usually required to provide structuring, the solvent, while preferably being water, can be an organic solvent which will vaporize either during the spray drying process and be completely removed during any subsequent heating process. Spray drying the slurry mixture yields particulate mixtures of the mineral and polyphosphate structuring agent. Moisture content is reduced below 5.0 wt. %, typically, below 2.0 wt. %. Subsequent to spray drying, a pulverization step to crush the spray dried particles can be useful in providing a uniform mixture of the mineral and structuring agent. Subsequent heating results in the reaction of the polyphosphate with the mineral and the formation of new internal structure within the mineral, providing additional pore volume and a higher surface area. Further heating to consolidate the material results in additional hardness and with the new added pore volume, the surface area of the treated mineral is not drastically reduced, as are untreated minerals. It is to be understood that while spray drying is preferably used to form a mixture of the mineral to be treated and the polyphosphate structuring agent, other mixing techniques can be used, as is well known in the mixing art.

The process of this invention can now be more specifically described for the treatment of hydrous kaolin to be used in paints, coatings, plastic fillers, etc. It is to be understood that the process, while essentially similar for all other types of minerals to be treated, may have certain details which differ from the treatment of kaolin. Hydrous kaolin particles approximately 0.20 to 10 microns in diameter are slurried with water in a solid range of 30 to 80 wt. %. More typically, the slurry will comprise 40-70% by weight hydrous kaolin solids and, still further, 50 to 65% by weight kaolin solids in water. Room temperature slurries can be prepared, although the slurry can be heated up to 150° F. if desired prior to entering the spray dryer. Mixed with the aqueous kaolin slurry is a polyphosphate, for example, a liquid ammonium polyphosphate, for example, fertilizer grade ammonium polyphosphate (11-37-0). Approximately, 0.01 to 5 wt. % of the ammonium polyphosphate as P₂O₅ can be mixed with the aqueous kaolin slurry relative to the kaolin solids. More preferably, the amount of polyphosphate structuring agent would be in the lower portion of the stated range, typically from about 0.05 to 0.2 wt. % P₂O₅ relative to the kaolin solids. The mixture of the aqueous hydrous kaolin slurry and liquid ammonium polyphosphate is now spray dried in conventional spray drying equipment. Spray drying can be done in a vacuum or at atmospheric pressure at temperatures between about 70° F. to 550° F. to remove the water.

The size of the spray dried particles comprising the mixture of hydrous kaolin and ammonium polyphosphate will generally range from about 25 to 200 microns. Prior to heating the spray dried particle mixture to induce the structuring reactions, it is preferred to pulverize the spray dried particles into a powder to provide a more uniform mixture of the ammonium polyphosphate and hydrous kaolin. The powder can then be heated in air in any calcining furnace. As the temperature is raised, the ammonium polyphosphate decomposes at or above 350° F. The decomposition products are predominately polyphosphoric and orthophosphoric acid. As heating continues, the hydrous kaolin is converted to metakaolin at which time the alumina in the mineral lattice becomes chemically active. Phosphate materials react with the aluminum sites in the kaolin to form new structuring within the kaolin particle. Importantly, surface iron in the hydrous kaolin, which can reduce brightness of the final product, is converted to iron orthophosphate which negates the traditional brightness reversion seen as the kaolin is more intensely fired. It is believed that the incremental structure within the kaolin particle is likely created, due to the polyphosphoric acid reacting with the chemically active aluminum present while products are in the metakaolin phase.

The low temperature decomposition of polyphosphates affords a structuring reaction to take place when kaolin transitions into the metakaolin phase. There are three unexpected benefits to a process that effectively extends the art of kaolin calcination. The first benefit is the creation of incremental surface area and pore volume in the kaolin lattice. This degree of structuring can be controlled making the lattice more absorbent. Second, the polyphosphate reaction driving structuring is at low temperature—well below the threshold temperature where metakaolin undergoes lattice reconfiguration to spinel and mullite. The newly created structure can serve as a sink to collect the silica expelled as metakaolin transitions to spinel and mullite with incremental heat treatment. This advantage significantly enhances the control capability of the calcination process and can leverage the use of fluxes i.e. sodium silicate, sodium borate, etc which can be used to lower the temperature at which the spinel and mullite transitions take place to produce unique lattice structures. To one skilled in the art of kaolin calcination, flux use has been of minimal value due to the acute control of heat treatment needed to achieve consistent results in terms of controlling pigment surface area, +325 mesh particle generation, and maintaining pigment brightness. Pre-treating kaolin with a polyphosphate abates these issues and will allow expanded utility of flux technologies going forward.

The kaolin is then heated to a temperature beyond the characteristic exotherm to form the spinel and mullite phases. It is hypothesized that the new structure that is formed during conversion to metakaolin is sufficient to trap some or all of the silica that is expelled as the kaolin is converted into the spinel and mullite phases. Unexpectedly, this essentially eliminates the formation of large +325 mesh agglomerates in the calcined product. This allows the intensive calcination of kaolin to a mullite phase without the customary development of excessive +325 mesh aggregates. The Mohs hardness of the calcined kaolin product can therefore be raised from the customary 4.5 range to 6.5 without agglomerate formation. This, for example, provides value in paint applications as scrub, burnish resistance and surface area are all positively impacted while maintaining needed film forming characteristics. Another benefit of the ammonium polyphosphate thermo-chemical structuring is enhanced spinel stability that can result in current products being produced at lower firing conditions.

The addition of the structuring agents to the minerals of this invention also provides advantages in not only in pore volume, but in the strength of composites forming one or more of the mineral components. Thus, the structuring agent has been found to provide improved binding between one or more minerals of different chemical composition, crystalline sizes and minerals which change crystal states, or which oxidize at different calcining temperatures. Thus, the addition of the structuring agent to one or more minerals provides improved particle strength to discrete powder aggregates formed during calcining of composite structures. The improved bonding provides opportunities to develop unique porous structures such as by the addition of organic additives like bulking polymers, or waxes that will structure particle aggregates during spray drying and burn out at relatively low temperatures. The addition of the polyphosphate structuring agent strongly binds what would normally be such fragile structures. Further, a broad range of anionic dispersed mineral blends can be formed to engineer stable calcined composites for target applications such as pigments, extending agents, polymer fillers and the like to provide desired physical, chemical and/or electrical properties. Non-limiting examples of such composites include mixtures of kaolin and magnesium oxide, kaolin and calcium oxide, blends of kaolin, magnesium oxide and calcium oxide, kaolin and alumina blends, blends of the above minerals with polymers, waxes, etc.

The paint industry supplies consumer-oriented products of the solvent and emulsion types. Solvent paints are relatively simple systems, easy to formulate but difficult for the consumer to use. Solvent paints contain a binder (oil or resin), a solvent (thinner), drying agents and pigments. Emulsion or so-called “latex” paints are complex mixtures containing latex surfactants, protective colloids, biocides, freeze-thaw stabilizers, emulsifiers and water in addition to the one or more types of pigment which may be used. Following their introduction after World War II, latex paints have gained substantially in market acceptance. They now account for a majority of interior and exterior paint trade sales.

The structured minerals of this invention include pigments that may be used in latex or solvent paints without departing from conventional formulations or formulation techniques. The pigment of this invention may also be used as an extender in conjunction with titania or other primary pigment. A significant advantage of the pigment of the present invention is that, relative to other common extenders, it may be used to replace more of the very expensive titania primary pigment in common formulations without decreasing chalking resistance or opacity.

The structured minerals of this invention can also be used as fillers for coatings, plastic films and molded plastic components. Thus, the structured minerals can be added as fillers to any plastic composition which typically included the filler materials. There is no specific limitation of the types of plastic, whether thermoplastic or thermosetting in which the structured materials can be incorporated.

### Example 1

In this example, the feed for a commercial calcined paint kaolin pigment is used to demonstrate how the addition of ammonium polyphosphate liquid (11-37-0) to the anionically dispersed spray dryer feed slurry can stabilize the mineral lattice and enhance calcined product brightness potential. The mineral in this example exhibits a particle size distribution of 86 to 90% less than 1.0 micron (as measured by Sedigraph 5100/5120 particle size analyzer) and a BET surface area of 20.0 to 22.0 m²/gm (Gemini 2370 surface area analyzer). 11-37-0 ammonium polyphosphate liquid was added at a rate of 0.50 weight percent P₂O₅ per dry ton of kaolin. The kaolin slurry concentration was in the 45 to 65% solids range.

The slurry was spray dried by a process equipped with a centrifugal atomizer. This method was selected for convenience. i.e. other drying methods would be equally effective with a goal to reduce product moisture to below 2.0 percent by weight (CEM Labwave 9000 moisture analyzer). The selected drying process yielded a bead average particle size (APS) of 65 to 75 microns as measured by laser particle size analysis (Microtrac SRA 150). The dried product was pulverized to a 5.0 Hegman Grind (ASTM D1210 Standard Test Method for Fineness of Dispersion of Pigment-Vehicle Systems by Hegman-Type Gage.) and then calcined in a muffle furnace capable of attaining and controlling clay bed temperatures as high as 2250° F. In this example, an electric muffle furnace was utilized with residence time under heat set at 1.0 hour. The calcined product was pulverized to simulate the deagglomeration process used in commercial pigment production. In the tables below, the degree of product heat treatment is expressed as relative mullite index (M.I). The value is derived by subjecting the calcined products to X-ray diffraction and measuring the mullite peak. The higher the M.I., the more intensively the product has been fired. To those experienced in the art and product applications, calcined kaolin fired to a 3.0 to 7.0 M.I. is considered “fully calcined”.

TABLE 1
Untreated Calciner Feed

| | | +325 | | Oil | | |
|---|---|---|---|---|---|---|
| Product | GEB | Mesh | Surface | Absorp- | PSD | PSD |
| MI | Brightness | Residue | Area | tion | @ 2 | @ 1 |
| 6.1 | 90.7 | 0.0136 | 11.27 | 62.2 | 56.6 | 37.2 |
| 11.7 | 90.7 | 0.0194 | 9.28 | 62.2 | 56.1 | 36.5 |
| 23.1 | 90.3 | 0.0229 | 7.7 | 60.6 | 53.1 | 28.1 |
| 30.6 | 90 | 0.0480 | 6.7 | 60.6 | 52.5 | 26.2 |
| 41.4 | 89.6 | 0.1798 | 6.26 | 62.2 | 50 | 23.2 |
| 52.9 | 89.5 | 0.1359 | 4.96 | 63.8 | 43.1 | 17.1 |

TABLE 2
Polyphosphate Treated Calciner Feed

| | | +325 | | Oil | | |
|---|---|---|---|---|---|---|
| Product | GEB | mesh | Surface | Absorp- | PSD | PSD |
| MI | Brightness | Residue | Area | tion | @ 2 | @ 1 |
| 12.4 | 92.4 | 0.0158 | 10.9743 | 68.4 | 71.8 | 52.0 |
| 16.7 | 92.3 | 0.0169 | 10.2682 | 71.5 | 70.0 | 48.1 |
| 31.8 | 92.3 | 0.0237 | 8.7446 | 72.3 | 69.4 | 42.3 |
| 42.2 | 92.6 | 0.0869 | 8.2085 | 73.1 | 67.6 | 38.9 |
| 49.7 | 92.7 | 0.1202 | 8.4999 | 71.5 | 68.2 | 38.3 |

Of particular interest are the benefits of higher product brightness and surface area maintenance as firing is intensified to increase the Mohs hardness/durability of the mineral matrix. Product brightness is measured by a Technidyne S-4 brightness tester set at an effective wavelength of 457 nm and calibrated relative to magnesium oxide with a brightness value of 100. Residue values (TAPPI Method T671) represent the weight percent of particles that are greater than 325 mesh in size. Product oil absorption was determined by the Spatula Rubout method (ASTM D281-95 (2007) Standard Test Method for Oil Absorption of Pigments by Spatula Rub-out).

### Example 2

The kaolin used in this example exhibited a particle size distribution of 86 to 90% less than 2.0 microns (as measured by Sedigraph 5120 particle size analyzer) and a BET surface area of 18.8 m²/gm (Gemini 2370 surface area analyzer). 11-37-0 ammonium polyphosphate liquid was added in increasing increments of from 0.15 to 0.35 weight percent P₂O₅ per dry ton of kaolin. The kaolin slurry concentration to spray drying was in the 45 to 65% solids range. Apparent bulk density (ABD) is the weight per unit volume of a material, including voids that exist in the tested material. It can also be called Bulk Density and provides a measure of the “fluffiness” of a material in its supplied form. Tamped bulk density (TBD) measures the propensity of a pigment to gradually pack more efficiently. This tendency was measured with a TAP-PACK Volumeter (ISO 787-11)

The structuring advantages brought about by the addition of polyphosphate to calcined kaolin feeds can also seen in mitigating changes in product bulk density as heat treatment is intensified. In Table 3, calcined product bulk density is shown as a function of degree of calcination expressed as relative mullite index (M.I.)

TABLE 3

| Sample ID | M.I. | ABD | TBD |
|---|---|---|---|
| 0.0% P2O5 | 20.8 | 0.19 | 0.40 |
| | 30.9 | 0.19 | 0.4 |
| | 40.7 | 0.2 | 0.42 |
| | 49.2 | 0.22 | 0.44 |
| 0.15% P2O5 | 17.5 | 0.17 | 0.34 |
| | 30.3 | 0.17 | 0.38 |
| | 41.0 | 0.18 | 0.38 |
| | 48.7 | 0.20 | 0.40 |
| 0.2% P2O5 | 22.0 | 0.17 | 0.35 |
| | 31.2 | 0.19 | 0.36 |
| | 37.6 | 0.18 | 0.38 |
| | 50.8 | 0.2 | 0.4 |
| 0.25% P2O5 | 22.9 | 0.18 | 0.35 |
| | 31.1 | 0.19 | 0.37 |
| | 41.0 | 0.19 | 0.39 |
| | 49.7 | 0.19 | 0.4 |
| 0.3% P2O5 | 22.8 | 0.19 | 0.35 |
| | 31.0 | 0.19 | 0.36 |
| | 37.6 | 0.2 | 0.4 |
| | 50.0 | 0.19 | 0.41 |
| 0.35% P205 | 22.9 | 0.18 | 0.35 |
| | 31.1 | 0.19 | 0.37 |
| | 37.4 | 0.19 | 0.39 |
| | 50.0 | 0.18 | 0.41 |

### Example 3

In Table 4, the calciner feed for a commercial paper pigment was treated with 3.22 modulus sodium silicate at a level of 1.2% SiO₂ per dry ton of kaolin. This feed was characterized as having a particle size distribution of 91.0% less than 1.0 micron (Sedigraph 5120 particle size analyzer) and a BET surface area of 21.1 m²/gm (Gemini 2370 surface area analyzer. The sodium silicate liquid was added to the spray dryer feed slurry. The calciner feed was spray dried to less than 2.0% moisture by weight (CEM Labwave 9000) and pulverized before lab calcination. Calcination residence time was 1.0 hour. Degree of calcination was determined by relative mullite index (M.I.) and the calcined product was pulverized to simulate the deagglomeration process used in commercial paper pigment production.

TABLE 4
Sodium Silicate Flux (1.2% SiO₂)

| | | +325 | | Oil | | | |
|---|---|---|---|---|---|---|---|
| Product | GEB | Mesh | Surface | Absorp- | PSD | PSD | |
| MI | Brightness | Residue | Area | tion | @ 2 | @ 1 | APS |
| 20.8 | 90.6 | 0.7402 | 9.92 | 52.9 | 52.4 | 35.7 | 5.32 |
| 28.9 | 90.4 | 0.9359 | 8.42 | 53.1 | 49.4 | 31.3 | 5.58 |
| 35.6 | 90.4 | 1.1289 | 8.01 | 53.1 | 47.5 | 29.0 | 8.42 |
| 39.5 | 90.4 | 1.7764 | 7.67 | 53.1 | 48.2 | 27.7 | 7.22 |

This work was repeated using the sodium silicate feed described for Table 4 to which 11-37-0 ammonium polyphosphate liquid was added at a rate of 0.50 weight percent P₂O₅ per dry ton of kaolin. Feed preparation and the calcination process were the same as described above. Results are shown in Table 5.

TABLE 5
Sodium Silicate Flux (1.2% SiO₂) + 0.50 P₂O₅

| | | +325 | | Oil | | | |
|---|---|---|---|---|---|---|---|
| Product | GEB | Mesh | Surface | Absorp- | PSD | PSD | |
| MI | Brightness | Residue | Area | tion | @ 2 | @ 1 | APS |
| 12.4 | 92.4 | 0.0158 | 10.9743 | 68.4 | 71.8 | 52.0 | 3.87 |
| 16.7 | 92.3 | 0.0169 | 10.2682 | 71.5 | 70.0 | 48.1 | 3.59 |
| 31.8 | 92.3 | 0.0937 | 8.7446 | 72.3 | 69.4 | 42.3 | 3.83 |
| 42.2 | 92.6 | 0.0869 | 8.2085 | 73.1 | 67.6 | 38.9 | 3.83 |
| 49.7 | 92.7 | 0.1202 | 8.4999 | 71.5 | 68.2 | 38.3 | 3.78 |

To further illustrate these stated advantages, a prototype paint pigment was generated where the calcined product relative mullite index was targeted at 50.0 M.I. 3.22 modulus sodium silicate was used to flux the pigment at a dosage of 1.75% SiO₂ per dry ton of kaolin. This treated calciner feed was amended with 0.10 weight percent P₂O₅ (11-37-0 liquid) for comparison. The kaolin feed was characterized as having a particle size distribution of 88.0% less than 1.0 micron (Sedigraph 5120 particle size analyzer) and a BET surface area of 20.6 m²/gm (Gemini 2370 surface area analyzer). The sodium silicate liquid and 11-37-0 liquid were readily added to the spray dryer feed slurry. The calciner feed was spray dried to less than 2.0% moisture by weight (CEM Labwave 9000) and pulverized before lab calcination. Calcination residence time was 1.0 hour. The calcined product was pulverized to simulate the deagglomeration process used in commercial paint pigment production. Results are shown in Table 6.

TABLE 6

| Product | Product | GEB | +325 Mesh | Oil | | | |
|---|---|---|---|---|---|---|---|
| Treatment | MI | Brightness | Residue | Absorption | PSD @ 2 | PSD @ 1 | PSD @ 0.5 |
| SiO2 | 48.7 | 88.5 | 6.07 | 45.1 | No Check | No Check | No Check |
| SiO2 + P2O5 | 49.8 | 89.0 | 0.72 | 49.8 | 38.2 | 16.5 | 5.2 |

The benefits of polyphosphate treatment seen in Table 6 are graphic. The product 325 mesh residue on the sample treated with only 1.75% SiO₂ was too agglomerated for efficient post pulverization and too coarse to be run on the Sedigraph 5120 particle size analyzer. This gross level of 325 mesh residue particles makes this product unusable in paint due to poor film forming characteristics. The same feed material incrementally treated with only 0.10% P₂O₅ resolves this issue and offers the benefit of improved product brightness.

In this example, the target temperature for thermal treatment was well in excess of the glass transition of the sodium silicate flux. With the sequential use of a polyphosphate additive, the migration of molten silica from the sodium silicate and from the kaolin itself can be directed into the mineral lattice as well as being used to aggregate particles. Particle structuring in terms of product particle size, surface area, porosity, and 325 mesh residue mitigation can now be aggressively manipulated and more discretely controlled using technologies currently in play to manufacture calcined kaolin pigments and components.

### Example 4

In this example, a dispersed kaolin feed slurry was first treated with polyphosphate, then spray dried and calcined. The spray dried product moisture was again controlled to less than 2.0% by weight but the pulverization step before heat treatment was eliminated. This approach was used to assess the benefits of polyphosphate addition in stabilizing/strengthening the cohesiveness of a fired mineral structure. Ammonium polyphosphate liquid (11-37-0) was the source of the polyphosphate treatment. The kaolin starting material was a typical dispersed hydrous slurry exhibiting a particle size distribution as measured by Sedigraph 5120 of 86% less than 2.0 microns and a BET surface area of 18.0 to 22.0 m²/gm. The slurry was treated with ammonium polyphosphate liquid to 0.50 and 1.0 percent by weight P₂O₅ and then spray dried to yield a bead average particle size (APS) of 65 to 75 microns as measured by laser particle size analysis. The spray dried beads were then calcined in a muffle furnace capable of attaining and controlling clay bed temperatures as high as 2250° F. In this example, an electric muffle furnace was utilized with residence time under heat set at 1.0 hour. Relative mullite index (M.I.) was used to measure degree of product heat treatment. An in-house Air Jet Attrition Index test (ASTM standard method D5757) was conducted. To be considered suitably attrition resistant, a maximum Air Jet Attrition Resistance Index of 3.0 was deemed necessary. To meet this hurdle, the untreated Control sample was calcined to a 31.0 M.I. The results are set forth in Table 7.

TABLE 7

| P2O5 Loading | Product M.I. | Air Jet Attrition Index |
|---|---|---|
| 0.0% | 31.0 | 2.46 |
| 0.50% | 27.0 | 1.84 |
| | 48.0 | 0.68 |
| 1.00% | 29.0 | 5.48 |
| | 50.7 | 2.70 |

The results from this study were unexpected. The addition of ammonium polyphosphate liquid at a 0.50% P₂O₅ treatment level clearly proved the viability of polyphosphate addition to stabilize/strengthen the cohesiveness of the fired mineral structure. With 1.0 percent by weight P₂O₅ addition, however, Air Jet Attrition results indicate that the increased degree of internal structuring from the polyphosphate reaction has offset its strengthening attributes. Firing the product treated with 1.0% P₂O₅ to a 50.7 M.I rectified the attrition resistance issue suggesting that the incremental molten silica expelled as spinel and converted to mullite migrated into the newly created structure, strengthening the aggregate particle structure.

### Example 5

A commercially available boehmite alumina slurry produced by Tor corporation is delivered predispersed at >60% solids by weight for end use. The typical physical properties are set forth below:

### Al₂O₃

### LOI 20% max

### Particle Size Distribution

D50 1 micron
D90 7 micron
Surface area 70 m²/gm 100 max
Crystal size of boehmite XRD-500 angstroms
Brookfield Viscosity-300-500 cp using #2 spindle, 20 rmp @65% solids

This boehmite slurry was treated with a very small amount (0.15%) Ammonium Polyphosphate, (APP). The low shear viscosity of the slurry increased slightly, but not above practical limits for pumping and spray drying.

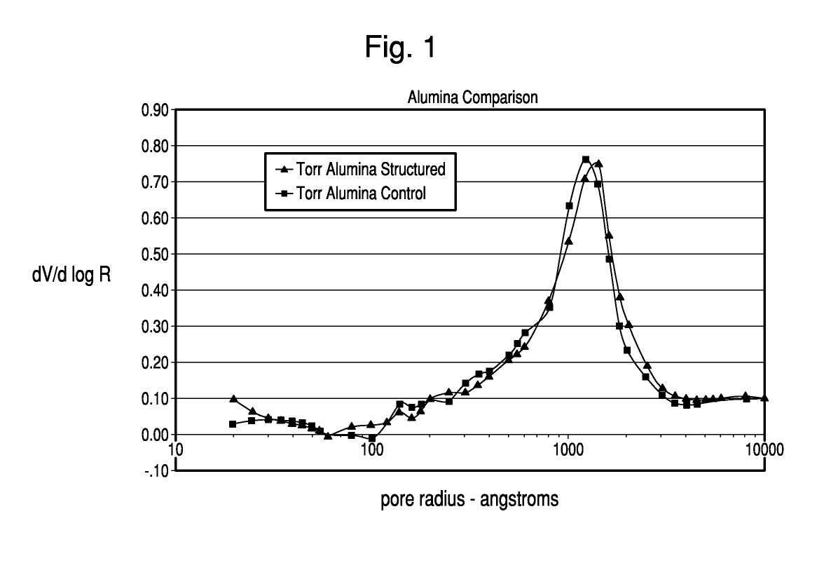

When spray dried and calcined to 1500° F., product temperature in a commercial calciner, 1400° F. in a muffle furnace, the boehmite converts to gamma/delta alumina. Note in FIG. 1, only a small incremental change in macroporous structure (>1000 angstroms) was measured. The total pore volume increased marginally from 0.4396 cc/gm to 0.4553 cc/gm.

Similar tests in previous examples demonstrate when APP structuring is applied to kaolin, higher or lower APP addition levels can produce a range of pore volume, surface area, and particle size distributions which can be controlled using differing amounts of APP. This example focuses on structuring alumina and adding a non-structured kaolin slurry to the structured alumina.

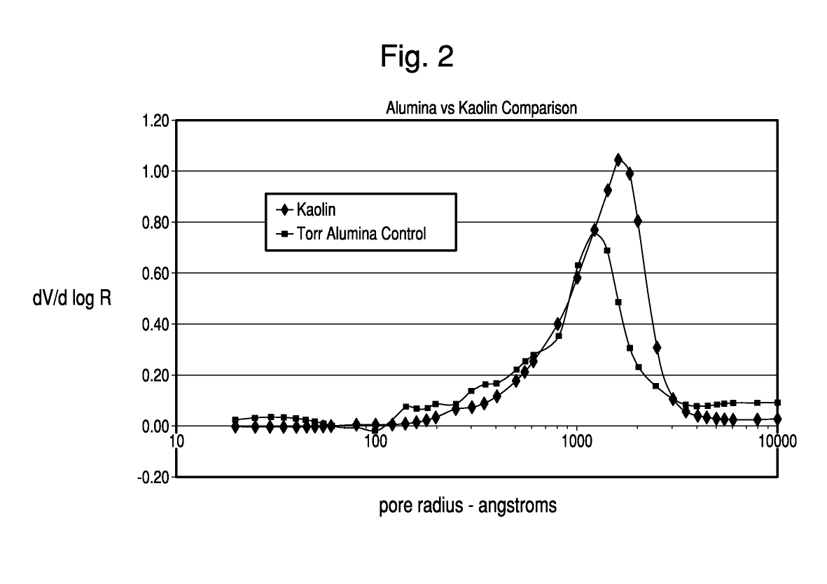

FIG. 2 illustrates the difference in pore structure of kaolin and a typical commercial boehmite as disclosed above.

A kaolin slurry was prepared by mixing (dry weight basis) 43% tertiary hydrous kaolin with 57% fully calcined kaolin with 36% mullite to form a stable slurry of approximately 51% solids. The commercially produced high solids boehmite slurry, as above described was added to the kaolin slurry at 19% dry weight basis. The ratio is approximately 4/1 kaolin/boehmite. The solids were adjusted as needed for spray drying. The binding agent was 3.22 modulus sodium silicate which was in-line injected at the spray dryer atomizer in a concentration necessary to provide adequate strength to the precursor for conveying and other requirements and assist in pore volume control. A typical value is 12% by weight.

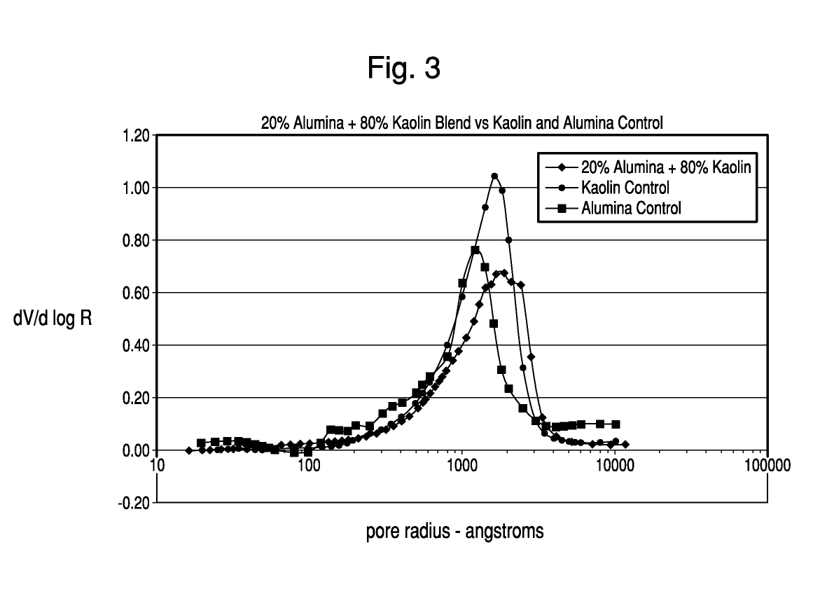

When comparing the pore volumes of the kaolin and boehmite slurries and the pore volume of the blend, as shown in FIG. 3, the dominant peak of blend is very similar to the alumina.

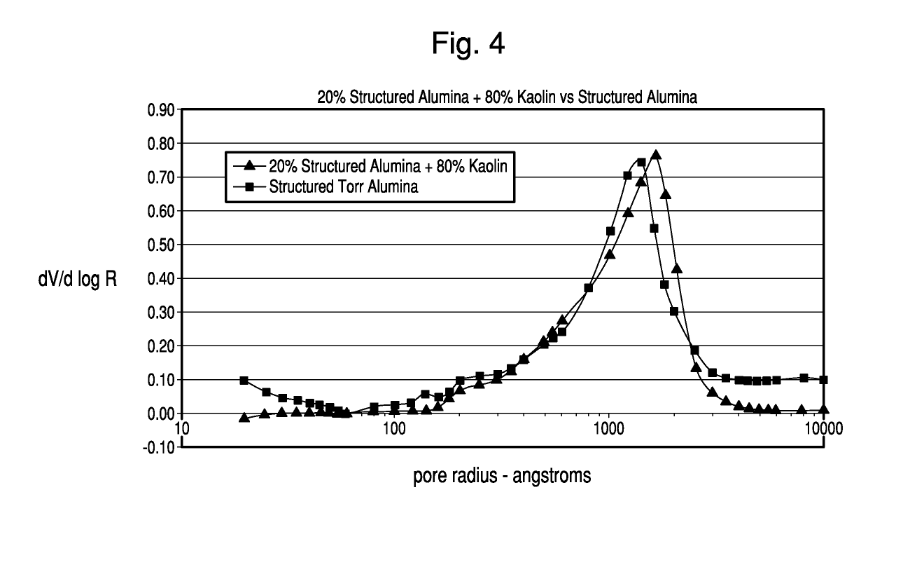

Structured alumina slurry, as above disclosed, was also blended with kaolin in the same 4/1 ratio, and compared with structured alumina. The results are shown in FIG. 4. Note from FIG. 4 that the dominant peak for the structured alumina and blend are very similar, while the large pore volume portion of the alumina slurry is eliminated in the blend, showing that the 4/1 kaolin/alumina mixture assumes the dominant structure of the alumina. This indicates thorough dispersion of the kaolin within the alumina structure.

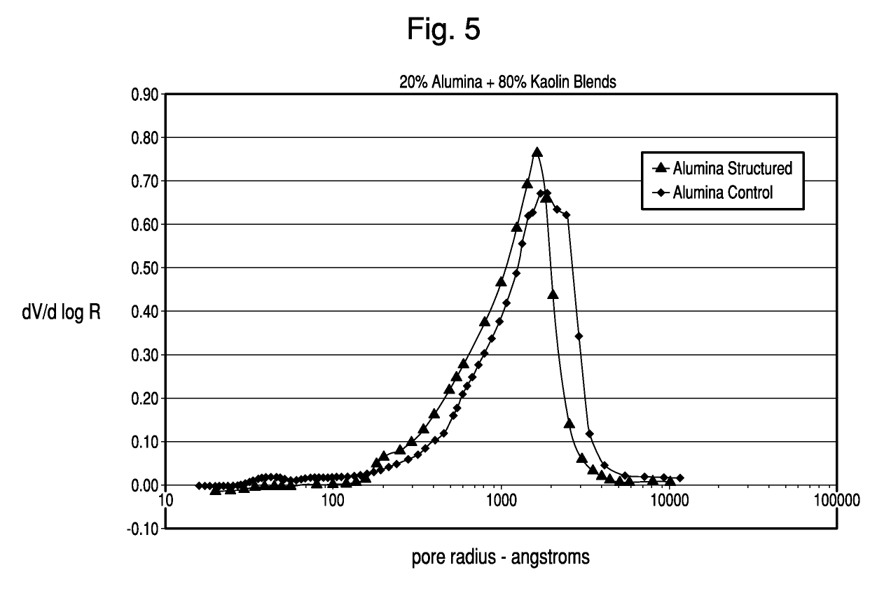

For comparative purposes is FIG. 5 showing the differences in the pore volume of the kaolin blends with structured and non-structured alumina. Note that the blend containing the structured product has a narrower distribution with additional volume in the 1000 angstrom pore radius.

1. A modified mineral formed by providing a mixture of a mineral which can be anionically dispersed in water and a structuring agent comprising polyphosphate and heating said mixture to react said structuring agent with said mineral.

2. The modified mineral of claim 1, wherein said mixture of said mineral and said structuring agent comprises from 0.01 to 5 wt. % of polyphosphate as P₂O₅ relative to the amount of said mineral.

3. The modified mineral of claim 2, wherein said mixture comprises 0.01 to 2 wt. % of polyphosphate as P₂O₅ relative to said mineral.

4. The modified mineral of claim 3, wherein said mixture comprises 0.01 to 0.5 wt. % of polyphosphate as P₂O₅ relative to said mineral.

5. The modified mineral of claim 1, wherein said mixture is formed by spray drying an aqueous slurry of said mineral and said structuring agent.

6. The modified mineral of claim 5, wherein said aqueous slurry includes a liquid polyphosphate.

7. The modified mineral of claim 6, wherein said liquid polyphosphate comprises ammonium polyphosphate.

8. The modified mineral of claim 6, wherein said aqueous slurry comprises a solid polyphosphate.

9. The modified mineral of claim 1, wherein said mixture is heated to a temperature of at least about 350° F.

10. The modified mineral of claim 1, wherein said mineral that is anionically dispersed changes crystalline phases upon heating.

11. The modified mineral of claim 10, wherein said mineral is kaolin and said mixture is heated to a temperature beyond the characteristic exotherm of said kaolin to form a spinel phase.

12. The modified mineral of claim 11, wherein said mixture is heated to a temperature beyond the characteristic exotherm of said kaolin to form a mullite phase.

13. The modified mineral of claim 12, wherein the modified mineral has a Mohs hardness of greater than 4.5

14. The modified mineral of claim 10, wherein said mineral which can be anionically dispersed comprises alumina.

15. The modified mineral of claim 14, wherein said alumina comprises boehmite.

16. A composite comprising a blend of the modified mineral of claim 1 and at least one other mineral.

17. The composite particle of claim 16, wherein said modified mineral comprises modified kaolin and/or modified alumina.

18. A paint comprising the modified mineral of claim 1.

19. A filled paper comprising the modified mineral of claim 1.

20. A filled plastic comprising the modified mineral of claim 1.
